(19) United States
(12) Patent Application Publication
(10) Pub. No.: US 2010/0018955 A1
(43) Pub. Date: Jan. 28, 2010

(54) DEVICE FOR RECORDING GRAPHICAL DATA ON A MEDIUM

(75) Inventor: Christophe Martinez, Grenoble (FR)

Correspondence Address: PEARNE & GORDON LLP, 1801 EAST 9TH STREET, SUITE 1200, CLEVELAND, OH, 44114-3108, US

(73) Assignee: COMMISSARIAT A L'ENERGIE ATOMIQUE, Paris (FR)

(21) Appl. No.: 12/503,447

(22) Filed: Jul. 15, 2009

(30) Foreign Application Priority Data
Jul. 24, 2008 (FR) 08 55080

(51) Int. Cl. B23K 26/36

(52) U.S. Cl. 219/121.69; 219/121.68

(57) ABSTRACT

This is a device for recording graphical data (34) on a medium (10), comprising a laser (9) producing a laser beam (14) to which the medium is sensitive, the laser beam projecting a spot (25) onto the medium (10), the laser (9) being driven in a relative sweeping movement with respect to the medium (10) during recording. It comprises means (32) of converting the grey level of each pixel into a pattern size (20) to be recorded on the medium (10), means (9a) for shaping the laser beam (14) so that the spot (25) projected onto the medium (10) is oblong and means of adjusting the size of the pattern (9b) acting on the switching on and off of the laser (9) and/or the power of the laser beam (14).

### TECHNICAL FIELD

The present invention concerns techniques for recording graphical data on a medium. The graphical data may be: images, photographs, documents, tables. Graphical data may be in black and white or in colour. If it is in black and white, it comprises a plurality of grey levels. If it is in colour, it comprises several colour half-tones. In the present patent application this expression “grey level” will also be used, but in this case this means “colour half-tone”. It proposes a device for recoding graphical data, a method of recording graphical data and a device for recording and reading graphical data recorded by the recording method.

### PRIOR ART

The problem of saving and storing graphical data is an old problem that must satisfy several criteria. First of all one of the key issues is saving space: it is a case of reducing, physically speaking, the space attributed to the storage of the graphical data. Next the saving must make it possible to reconstruct graphical data, during a reading step, from the graphic data recorded, so that they are as close as possible to the original graphical data that were recorded. In addition, the method must be rapid in recording and/or read mode. Finally, the graphical data recorded must be able to be used for a long time after the writing without degrading.

In patent U.S. Pat. No. 3,319,518, a technique is proposed for storing graphical data in which the graphical data are recorded on a small photosensitive medium. This is a microfilm. This solution remains very limited since the storage capacity remains low: the graphical data are reduced solely by a factor of 25. Next, the chemical post processing relating to the storage technique requires a long writing time, and is limited solely to the photosensitive medium.

An improvement is afforded in the patent U.S. Pat. No. 6,442,296. The graphical data are inscribed dot by dot by means of a laser on a medium of the optical disc type. This method is still not very well suited to the requirements of saving graphical data, since the medium remains writable even after the recording.

European patent EP 1 310 950 A2 proposes the recording of graphical data on a photosensitive medium. For this purpose it uses the near field technique for recording graphical data with a reduction factor. The graphical data on a medium have a characteristic size of 500 μm. This technique does however remain limited to media of the photosensitive optical disc type.

FIG. 1A shows a roughly circular pattern digitised on a square grid during a lithography step. The digitisation effect does not make it possible to obtain a circular pattern of good resolution. Moreover, incrementing the size of the pattern is done by a jumping by a value equal to that of the elementary pixel. For a given number of pixels the size range available is therefore limited. This case corresponds typically to the fabrication of a pattern from a projection system based on an image matrix of the spatial light modulator type. Lithography techniques can currently allow the fabrication of patterns on the basis of a more complex form (diamond assembly) but the limitation relating to the incrementatic,n of the sizes remains similar.

FIG. 1B shows the previous principle in the case of writing by sweeping with a laser beam. The resolution on the form of the patterns is given, this time, not by the size of the elementary pixel but by the successive sweeping step of the beam.

### DISCLOSURE OF THE INVENTION

The aim of the present invention is to propose a solution to the problems of saving graphical data.

In particular it proposes a solution that first of all makes it possible to inscribe very quickly, contrary to the prior embodiments where it was necessary to make several laser passes in order to inscribe the pattern. This is because the proposed solution minimises the number of laser beam passes writing on a medium, since it makes it possible to inscribe, by means of a single pass of the laser beam, an entire pattern.

Another aim of the invention is to propose to record graphical data in an analogous physical format of reduced size which does not pose problems of adaptation of reading formats, even a long time after the recording.

Another aim of the invention is to propose to record graphical data reliably and in a commercially viable manner.

Yet another aim is to propose a recording method adaptable to all types of media, that is to say of variable geometric shapes, flat, circular, cylindrical, but also of different sensitivities; they may be sensitive to instantaneous light intensity, such as is the case with thermosensitive materials, or sensitive to exposure, or dose, as is the case with photosensitive materials.

To achieve these performance objectives the present invention proposes a device for recording graphical data on a medium, in which each graphical data item has pixels that can take several grey levels. It comprises a laser producing a laser beam to which the medium is sensitive. This laser beam projects a spot onto the medium. The laser is driven in a relative sweeping movement with respect to the medium during recording. According to the invention it also comprises means of converting the grey level of each pixel into a pattern size to be recorded on the medium, means for shaping the laser beam so that the spot projected onto the medium is oblong and has a dimension in the sweeping direction smaller than a dimension in a direction substantially perpendicular to the sweeping direction, and means of adjusting the size of the pattern acting on the switching on and off of the laser and/or the power of the laser beam.

Thus, instead of using a conventional recording device, in which the laser beam sweeps the medium several times in order to inscribe the pattern in a mesh, the present invention proposes a recording device in which the laser beam makes a single pass over the mesh in order to inscribe the pattern, the inscribed pattern having an adjustable size by acting on the power of the laser beam and/or on the duration of switching on of the beam. Each pattern corresponds to a pixel of the graphical data item to be recorded, the size of the pattern being correlated with the grey level of the pixel.

In a variant of the invention, the means for shaping the laser comprise a focussing device placed downstream of the laser.

According to one characteristic of the invention, the means for shaping the laser beam can comprise a cylindrical telescope with at least two cylindrical lenses with different focal lengths, placed downstream of the laser and upstream of the focussing device. In this way it is possible to obtain an oblong spot without losing part of the power of the beam.

According to this characteristic, at least one of the cylindrical lenses is exchangeable. This makes it possible to work with several types of medium.

According to another variant, the means for shaping the laser beam can comprise an obturator placed downstream of the laser and of the focussing device.

According to yet another variant, the means for shaping the laser beam can be an aberrant element included in the focussing device.

Advantageously, the recording device can also comprise means of slaving the position of the shaping means with respect to the medium in order to optimise the recording.

The means of adjusting the size of the pattern can comprise means of modulating the laser beam. These means make it possible to obtain a rapid modification to the size of the pattern and thereby a high recording speed.

The means of converting the grey level of each pixel into a pattern size to be recorded comprise a conversion table.

According to the invention, each pattern is inscribed in a mesh on the medium. The means of adjusting the size of the pattern adjust both the period for which the laser is switched on and the start of the switching on so that each pattern is centred or decentred in the mesh.

When the pattern is decentred in the mesh, the size of the pattern represents the amplitude of a transform of the grey level and its decentring the phase of the transform of the grey level. Thus a larger quantity of information can be coded in this embodiment.

The means of adjusting the size of the pattern and/or the conversion means according to the invention can also take into account the nature of the medium.

The invention also proposes a device for recording and reading graphical data. It comprises a recording device according to the invention and a device for reading the graphical data recorded by the recording device. The reading device comprises a laser intended to irradiate the medium with a laser beam and an optical device for collecting the beam that has interacted with the medium. The means of converting the grey level of each pixel into a pattern size to be recorded on the medium take into account a percussional response of the optical collecting device.

The invention also proposes a method of laser recording of graphical data on a medium sensitive to a laser beam produced by the laser. Each graphical data item has pixels that can take several grey levels. According to the invention, a pattern size to be recorded on the medium is determined for each pixel of the graphical data. This size depends on the grey level of the pixel. The laser and the medium are driven in a relative sweeping movement. The laser beam is shaped so that it projects an oblong spot onto the medium. This spot has a dimension in the sweep direction smaller than a dimension in a direction substantially perpendicular to the sweep direction. The switching on and off of the laser and/or the power of the laser beam are acted on so that the pattern currently being recorded has the required size.

According to one characteristic of the recording method, each pattern is recorded in a mesh on the medium. The meshes form a succession. The switching on of the laser is adjusted for the recording of a pattern in a given mesh as from an instant where the laser is passing over the centre of the mesh preceding the given mesh.

Preferably the power of the laser is regulated so as to adjust the dimension of the spot in the direction substantially perpendicular to the sweep direction.

### BRIEF DESCRIPTION OF THE DRAWINGS

The present invention will be better understood from a reading of the description of example embodiments given, purely by way of indication and in no way limitatively, with reference to the accompanying drawings, on which:

FIGS. 1A and 1B (already described) show patterns inscribed on media by known recording devices;

FIG. 2 shows a device for recording graphical data on a medium according to one of the embodiments of the present invention and a device for reading graphical data recorded by the recording device according to the invention;

FIGS. 3A, 3B show two different patterns inscribed on a medium by the recording device of the invention as well as, for each of the patterns, the period during which the laser has been switched on;

FIG. 4A shows a graphical data item to be recorded with its grey levels before it is processed by the recording device of the invention;

FIG. 4B is the result of the recording of the graphical data item shown in FIG. 4A, carried out with the recording device of the invention;

FIG. 5A shows a laser beam that can be used in the context of the invention;

FIG. 5B shows various sizes of laser beam spots, obtained by virtue of the recording device of the invention;

FIG. 6 is a graph showing circular laser beam intensity sections in cases that do not relate to the invention;

FIG. 7 is a range of patterns corresponding to different grey levels, obtained with a recording device of the invention in the case where the medium is photosensitive;

FIG. 8 is a graph showing the standardised power of the laser and the ratio between the surface of the pattern and the surface of the mesh in the case where the medium is photosensitive;

FIG. 9 is a range of patterns corresponding to different grey levels, obtained with a recording device of the invention in the case where the medium is thermosensitive;

FIG. 10 is a graph showing the standardised power of the laser and the ratio of the surface of the pattern to the surface of the mesh in the case where the medium is thermosensitive;

FIG. 11 shows means of shaping the laser beam used in a recording device according to the invention;

FIG. 12 shows a variant of the means of shaping the laser beam used in a recording device according to the invention;

FIG. 13 shows yet another variant of the means of shaping the laser beam used in a recording device according to the invention;

FIG. 14 shows a device for enslaving the position of the laser beam shaping device used in a recording device according to the invention;

FIG. 15 shows an example of a recording medium of the optical disc type that can be used with a recording device according to the invention;

FIGS. 16A, 16B and 16C show three methods of processing recording media inscribed by the writing device contained in a recording device according to the invention;

FIG. 17 illustrates a variant of a recording device according to the invention functioning in another way and the sequences of switching on and off the laser used to obtain the recorded patterns;

FIG. 18 shows a functional diagram of the reading and writing method according to the invention as well as of the method of reading graphical data recorded by the recording method;

FIGS. 19A and 19B show two patterns of maximum sizes recorded by the method of the invention;

FIG. 19C shows a graph that presents the change in the surface ratio RS according to the size of the spot in the sweeping direction.

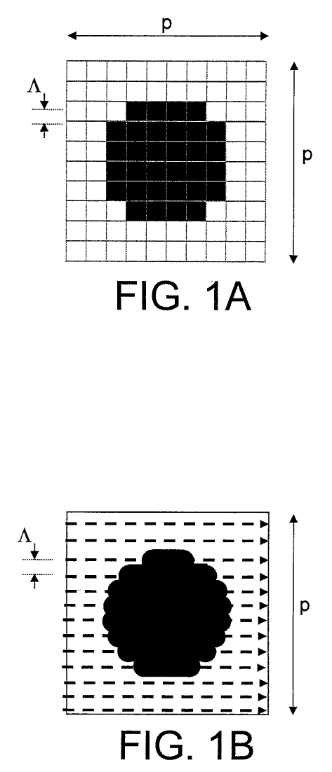

### DETAILED DISCLOSURE OF PARTICULAR EMBODIMENTS

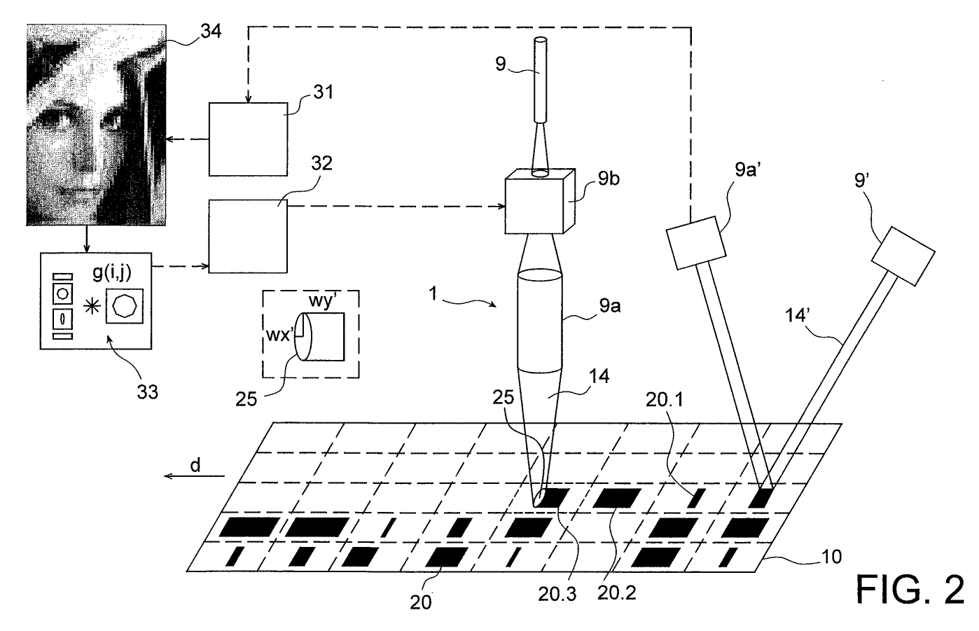

FIG. 2 shows a device for recording graphical data items 34 and a device for reading the graphical data items recorded. A graphical data item 34 to be recorded comprises a plurality of pixels Pi that can take grey levels issuing from a range of grey levels. It is recalled that grey levels may represent half tones if the graphical data item is in colour. It is assumed in the example described that the graphical data item 34 is a photograph.

The recording device comprises means 32 of converting the grey level of each pixel Pi of the graphical data item 34 to be recorded into a given size of pattern, by means of a conversion table 33 that makes a grey level correspond to a given pattern size. Each pixel Pi will be recorded in the form of a pattern recorded on a medium 10.

It also comprises a writing device 1 of the patterns 20. The writing device 1 comprises a cascade with a laser 9 and downstream shaping means 9a of a laser beam 14 produced by the laser 9. These shaping means 9a include a focussing device, not visible in FIG. 2. The laser beam 14 passes through the shaping means 9a and emerges at the exit from the shaping means 9a while being convergent. The writing device 1 also comprises adjustment means 9b of the size of the pattern acting on the switching on and off of the laser and/or the power of the laser beam.

These adjustment means 9b can be formed by modulation means placed downstream of the laser 9 but upstream of the shaping means 9a. The laser is then continuous. In a variant, they can be integrated in the laser 9. The laser functions in alternation (on/off). The adjustment means 9b function at a characteristic frequency fₗₐₛₑᵣ. The optical device 1 is intended to cooperate with a medium 10 sensitive to the laser beam 14 on which the patterns 20 will be inscribed. In the figure three patterns are referenced 20.1, 20.2, 20.3 and have just been inscribed or are in the course of inscription. The laser beam 14 that emerges from the shaping means 9a is focussed on the medium 10 placed in a focussing plane of the shaping means 9a. The shaping means 9a are intended to shape the optical beam so that an oblong spot 25 is projected onto the medium 10.

A relative movement is provided between the laser 9 and the medium 10 so that the laser beam 14 is driven in a movement of sweeping the medium 10 in a given direction d, at a substantially constant speed, this speed being called the linear speed.

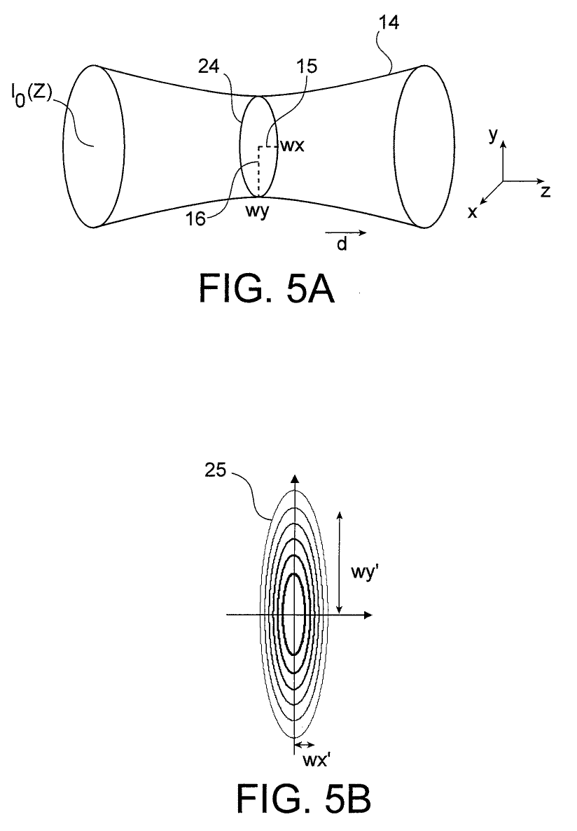

The oblong-shaped spot 25 has a dimension wx′ in the sweep direction d and a dimension wy′ in a direction substantially perpendicular to the sweep direction. FIG. 5B illustrates various spot sizes 25 delivered by various shaping means 9a and the dimensions wx′, wy′ are referenced. The dimension wx′ in the sweep direction is smaller than the direction wy′ in the direction substantially perpendicular to the. sweep direction. The laser beam 14 is used to inscribe the patterns 20 in the medium 10 sensitive to the laser beam 14, each located in a mesh 17 situated on the surface of the medium 10. Generally the meshes are notional. Contiguous meshes 17 form a succession and can be arranged in rows and columns, in a spiral or in a helix for example. The meshes 17 are marked by broken lines in FIG. 2. The meshes 17 are identical, for example, but this is not obligatory.

The patterns 20.1, 20.2, 20.3 also have an adjustable size, as can be seen in FIG. 2. The pattern 20.3 is in the course of inscription and the patterns 20.1, 20.2 are already inscribed, the pattern 20.1 having a smaller size than the pattern 20.2.

The size of the pattern 20 recorded on the medium 10 depends on the size of the spot 25, this size depending on the shaping means 9a used but also on the power of the laser 9 and the period for which the laser is switched on. The higher the power of the laser 9, the larger will be the dimension wy′ of the spot 25.

As for the size of a pattern 20, this will depend on the size of the spot 25 but also on the period for which the laser 9 is switched on and the sweep speed of the laser 9. However, it is assumed that the sweep speed is constant.

The longer the period of switching on, the greater the dimension of the pattern 20 in the sweep direction d. Its dimension in a direction substantially perpendicular to the sweep direction corresponds substantially to the dimension wy′ of the spot 25.

Since the grey level of a pixel Pi depends on the size of the pattern 20 that corresponds to this pixel, the second pattern 20.2 corresponds either to a darker pixel that the pixel Pi to which the first pattern 20.1 corresponds, or the converse.

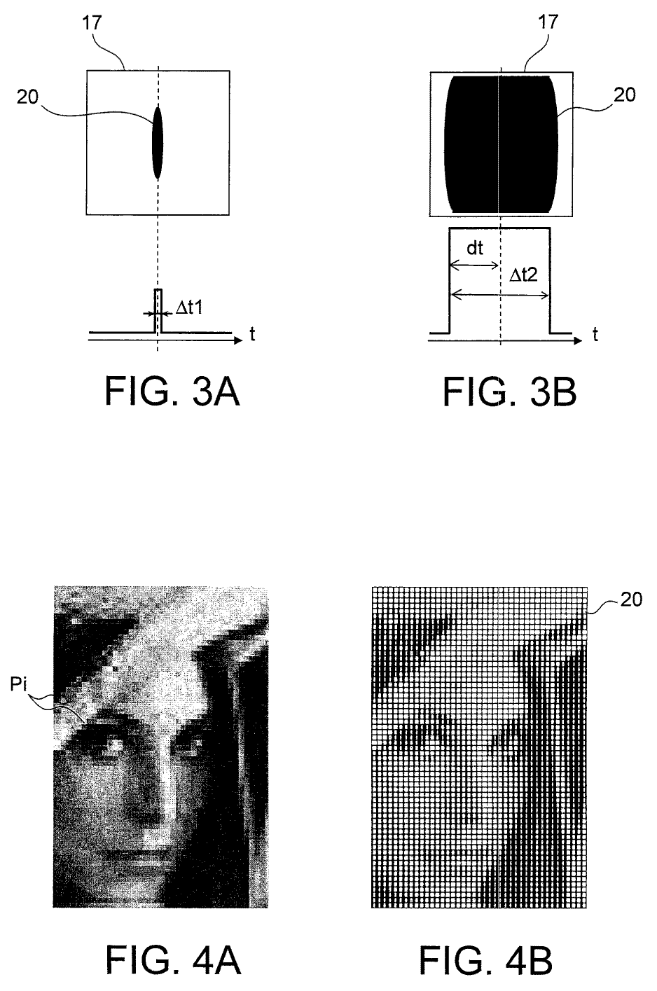

FIGS. 3A, 3B show two patterns 20 inscribed in a mesh 17 on the medium, these having different sizes. The power level and the period for which the laser used for inscribing these patterns 20 is switched on are also shown. In both cases, the laser beam sweeps the medium. In FIG. 3A, the period of switching on Δt1 is short and the power level of the laser also. The pattern 20 is of small size compared with the size of the mesh 17. In FIG. 3B on the contrary, the switching-on period Δt2 is long and the power level of the laser is higher. The pattern 20 has a size that approaches the size of the mesh 17. It can be noted that, in both cases, the pattern 20 is substantially centred in the mesh 17. It will be seen later that this is not obligatory. In FIG. 3B, it can be seen that the switching on of the laser 9 begins with an advance dt, before the laser 9 points to the centre of the mesh 17, while in FIG. 3A the switching on of the laser takes place only a very short time before the laser points to the centre of the mesh 17.

Thus this recording device makes it possible to inscribe a pattern 25 through a single pass of the laser beam 14, unlike the techniques known up till then.

FIGS. 4A and 4B show the results of a recording method using the recording device described in FIG. 2. The graphical data to be recorded shown in FIG. 4A is a data item formed by pixels Pi in grey levels. That is to say each pixel of the graphical data item represents a light intensity. FIG. 4B shows the graphical data as recorded on the medium 10 in the form of patterns 20, by means of the recording device of the invention. The grey level of a recorded pixel is given by the ratio of the surface of the pattern 20 to the surface of the mesh 17.

FIG. 5A shows a laser beam 14 that can be characterised by its intensity at the centre of the beam I₀(z) in a plane perpendicular to the propagation direction d, and by its waist 24. In the present recording device, the waist 24 situated at the exit of the laser beam shaping means is oblong in shape with a major axis 16 of dimension wy and a minor axis 15 of dimension wx. A Gaussian beam is spoken of here, that is to say a beam the amplitude of which is described by an exponential function A(x)=exp(−x²/w²). The parameter w is such that, if x=w, the amplitude of the signal is equal to A(w)=exp(−1)=1/e.

In terms of beam intensity, there is the same thing I(x)=A²(x)=exp(−2x²/w²). The parameter w is then such that, if x=w, the intensity is I(w)=exp(−2)=1/e².

In general terms the waist is called w and it is described as the radius of the beam corresponding to the value exp(−2) of the intensity.

wy and wx are the radii at 1/e² of the beam intensity distribution.

FIG. 5B shows various spots 25 resulting from various waists 24 obtained according to the device of the invention. These spots make it possible to obtain patterns of different sizes for representing the various grey levels of the pixels of the graphical data to be saved.

In the device of the invention, circular spots will not be used. It will be explained why.

This is because, in this case, the dimensions of the waist are such that wx=wy=w0, w0 representing its radius. In the case of a thermosensitive medium 10, that is to say sensitive to the heating of the material caused by the light intensity, it is possible to calculate the radius rₛ of the laser beam spot in the focussing plane, knowing the diameter of the waist, the saturation light intensity Iₛ as from which the medium is modified by the irradiation, and the energy E₀ of the laser beam. The radius rₛ of the spot follows a logarithmic progression described by the following formula:

$${r}_{s}^{2} = \frac{{w}_{0}^{2}}{2} ln [ \frac{2 \times {E}_{0}}{{I}_{s} \times π \times {w}_{0}^{2}} ]$$

The radius of the spot, for a given material, therefore depends on the energy of the laser beam and on the radius of the waist. The energy of the laser beam is fixed by the adjustment of the laser power.

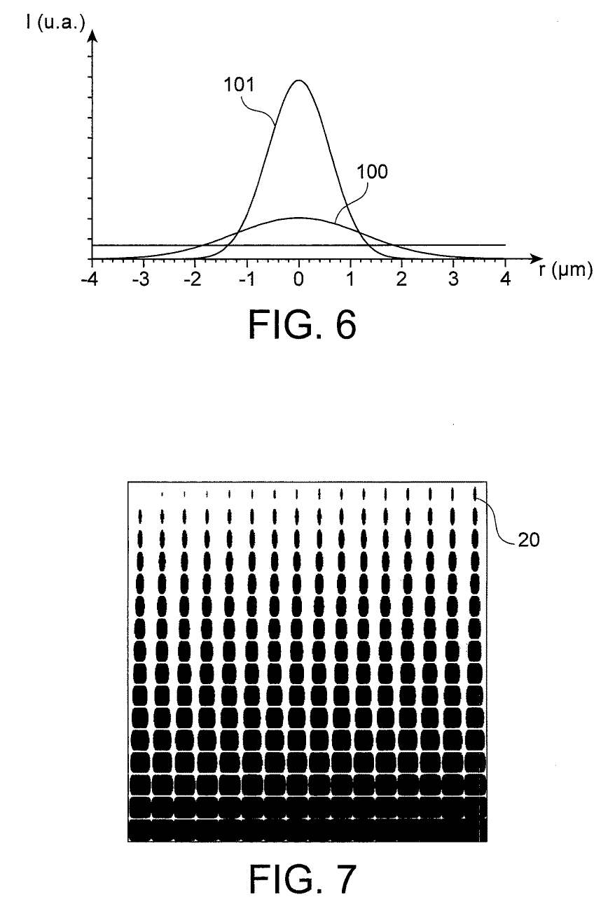

FIG. 6 shows two sections 100, 101 of the profile of the saturation light intensity Is of a laser beam in a plane perpendicular to the propagation direction. The first section 100 is obtained with a waist of radius w0=2.5 μm, and the second section with a radius w0=1.2 μm. In the first section 100 the radius rₛ of the spot is equal to 2.1 μm, and in the second case is equal to 1.4 μm. It is possible to control the size of the spot of a laser beam in the focussing plane only by controlling its intensity. However, a circular spot poses two major problems. First of all, because of the logarithmic progression of the radius of the spot rₛ, this device is not advantageous. This is because this progression means for example that, in order to obtain a spot radius of 2.1 μm from a waist radius w0 of the 1.2 μm, it would be necessary to multiply the power of the laser by twenty, with respect to the beam with a waist radius w0 of 2.5 μm. Next, as can be seen in FIG. 6, in the case where the radius of the waist is equal to 1.2 μm, the intensity at the centre of the beam may be very high to the point of damaging the medium for small waist sizes. The change in power of a laser mounted on means of shaping the laser beam with a circular section would therefore not make it possible to easily obtain by itself alone a range of patterns of variable sizes for the required use. These are the reasons why, in the case of the invention, the shaping means model a laser beam projecting an oblong spot onto the medium.

With the recording device according to the invention, it is possible to use a medium of the photosensitive type, that is to say sensitive to the exposure or dose. It will be recalled that the dose corresponds to the time integral of the light intensity of the spot. A laser is chosen having a final power such that the material of the medium has a dose threshold equal to 69% of a maximum dose which corresponds to the dose used to form the largest pattern. With such a medium, the writing device can have the following characteristics:

wx>195 nm

wy=1.3×p, where p represents the side of a mesh that in the example is substantially square, this dimension corresponding substantially to that of a pixel of the graphical data to be recorded. A suitable value of p is 1 micrometre for example

fₗₐₛₑᵣ=250 MHz

It should be noted that the size of the spot along x is bounded by the diffraction limit with shaping means having a numerical aperture of 0.9 and a laser beam wavelength of 405 nm, wx>193 nm is obtained.

In the recording device of the invention, the movement of the spot within a mesh is proportion to the grey level of the pixel to be recorded in said mesh. This movement of the spot 25 can be zero, which corresponds to a pattern of minimum size and to a minimum grey level, and range up to 1.45×p, which corresponds to a pattern of maximum size and to a maximum grey level. When there is an overflow of a pattern onto the following mesh, there is a risk of overlap with the pattern to be inscribed in the following mesh, but the phenomenon is not a problem if it is not corrected. It should be noted that the image can be modified, before writing, with error diffusion algorithms. Such a modification makes it possible to control the overflow effect.

The power of the laser is maintained substantially constant and equal to 90% of the final level for three quarters of the first lowest grey levels, and is then increased so as to reach the final level according to the following equation:

$${Pn}_{i} = 0.9 for i = 1 to 3 N / 4$$

$${Pn}_{i} = 0.9 + 0.1 {x ( \frac{i - 3 N / 4}{N / 4} )}^{2} for i = 3 N / 4 to N$$

where N designates the number of grey levels required, i the rank of the grey level in the increasing succession of grey levels, and Pnᵢ the standardised power at the laser exit for the grey level of rank i.

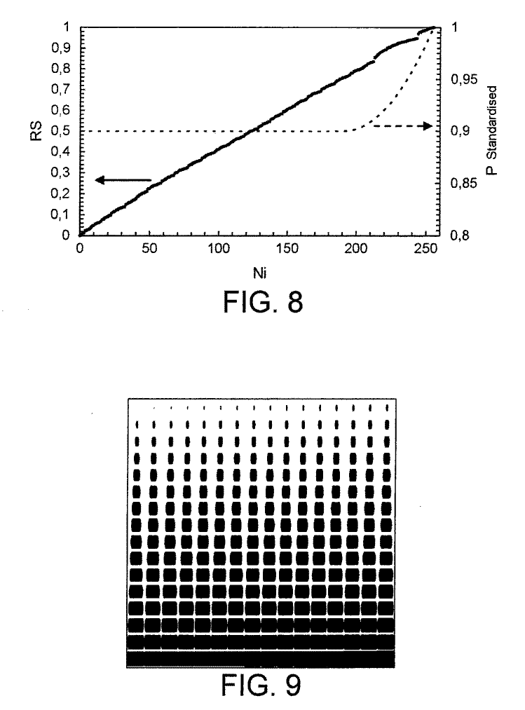

FIG. 7 shows a range of recorded patterns representing a range of grey levels. This range of patterns corresponds to 256 grey levels that can be coded according to this embodiment of the invention. A pattern is depicted in black on a white background. The patterns are disposed in increasing order of their size. That is to say the pattern of zero size, and corresponding to white, is at top left, while the pattern of maximum size and corresponding to black is at bottom right. FIG. 8 is a graph presenting on the X axis the indices of the 256 grey levels classified in increasing order and on the Y axis, on the left, the ratio RS of the surface of the pattern to that of the mesh and on the right the standardised power at the exit of the laser.

The curve in a solid line therefore expresses the ratio RS for each grey level Ni. It is possible to observe a linear increase in this ratio RS according to the grey level, as would be desired. The curve in the broken line expresses the standardised power for each grey level Ni. It will be observed that this power is constant for ¾ of the first grey levels, from rank 0 to 192, and then increases up to rank 256.

With the recording device according to the invention, it is possible to use a medium of the thermosensitive type. There is no longer any concept of dose with this type of medium. The absence of cumulative effect on the laser beam means that the powers involved must be lower in particular for small patterns. This type of medium imposes another sizing of the laser beam and another choice of laser power.

With such a medium, the writing device can have the following characteristics:

wx>195 nm

wy=0.85 xp

fₗₐₛₑᵣ 256 MHz

The power of the laser is chosen so that the maximum power corresponds to twice the power as from which the material is sensitive. In the same way as the previous embodiment, the period of switching on of the laser is proportional to the grey level of the pixel to be recorded. The minimum movement of the spot is always substantially zero. On the other hand, unlike the previous case, the maximum movement of the spot corresponds to p, which is a side of the mesh.

As for the power of the laser, this increases over approximately half of the lowest grey levels, and is then substantially constant at the central part of the range of grey levels, and then once again increases up to the maximum value, following for example the following law:

$${Pn}_{i } = 0.8 - 0.3 {x ( \frac{N / 2 - i}{N / 2 - i} )}^{1.5} for i = 1 to N / 2$$

$${Pn}_{i } = 0.8 + 0.2 {x ( \frac{i - N / 2}{N / 2} )}^{4} for i = N / 2 to N$$

FIG. 9 is similar to FIG. 7 and represents a range of patterns representing a range of 256 grey levels.

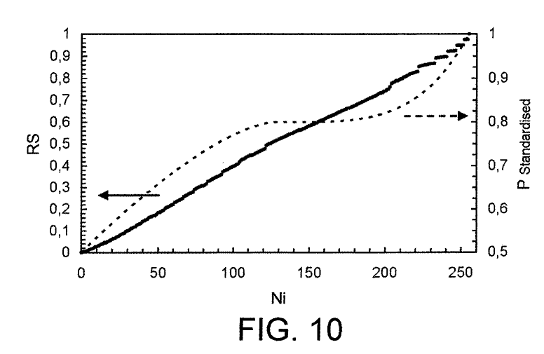

FIG. 10 is similar to FIG. 8. The trend of the standardised power curve is indeed in accordance with what was disclosed above with three phases, including two increasing ones framing a substantially stable phase.

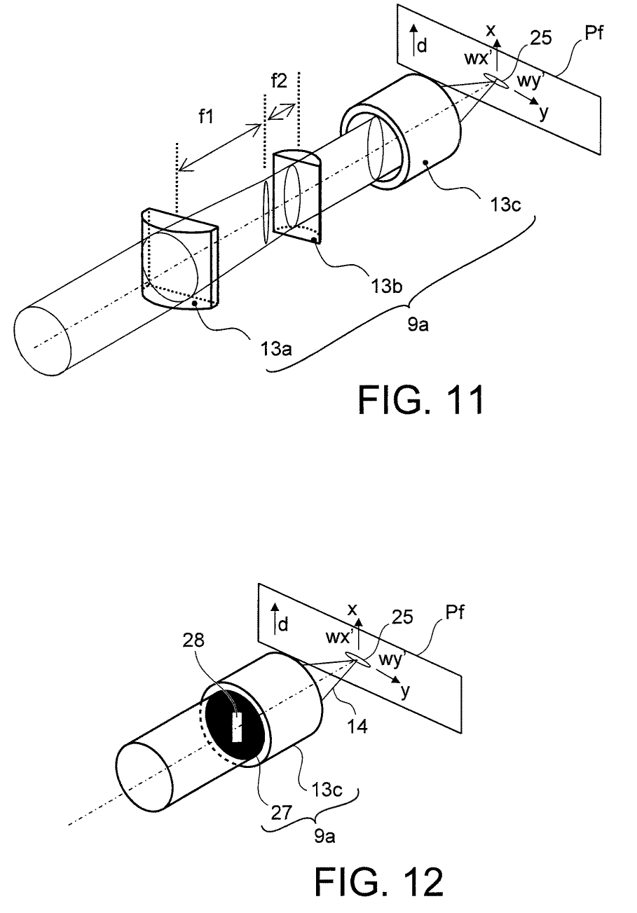

FIG. 11 shows a first embodiment of shaping means 9a for obtaining an oblong spot 25. They comprise firstly a cylindrical telescope comprising at least two cylindrical lenses 13a, 13b with generally different focal lengths, disposed one after the other in a substantially afocal configuration, and secondly a focussing device 13c downstream of the cylindrical lenses 13a, 13b. The cylindrical lenses 13a, 13b of the cylindrical telescope make it possible to keep the parallelism of the laser beam 14 while anamorphosing it, that is to say giving an oblong shape to a cross section of the laser beam 14. This oblong shape is substantially elliptical. Each of the cylindrical lenses 13a, 13b makes it possible to control respectively the dimensions of the waist of the laser beam 14. The focussing device 13c for its part makes it possible to focus the laser beam 14 in a focussing plane Pf. The spot 25 projected onto the focussing plane Pf does indeed have a dimension wx′ along x that is smaller than its dimension wy′ along y. In the recording device according to the invention, the sweep direction d is along x. Such shaping means 9a of the cylindrical telescopic type offer the possibility of easily modifying the dimension wy′ of the spot 25 by having available several cylindrical lenses 13b that are exchangeable. By replacing, in the cylindrical telescope, the lens 13b with another, having a different focal length f2, it is possible to record graphical data having different pixel sizes or to implement backups on media made from different materials.

Another embodiment of the shaping means 9a making it possible to obtain an oblong spot 25 is illustrated in FIG. 12. They comprise an obturator 27 placed downstream of the laser (not shown) and is followed by the focussing system 13c. The obturator 27 is provided with an oblong opening 28. The obturator makes it possible to partially stop the laser beam 14 and to allow to pass only part of the laser beam at the oblong opening 28. The laser beam passing through the obturator 27 is then focussed by the focussing device 13c in the focussing plane Pf. The opening 28 is shown as substantially rectangular in the example described, but other oblong shapes are of course possible. One drawback of this embodiment with respect to the system with the cylindrical telescope is that the power of the laser beam is reduced after passing the obturator 27.

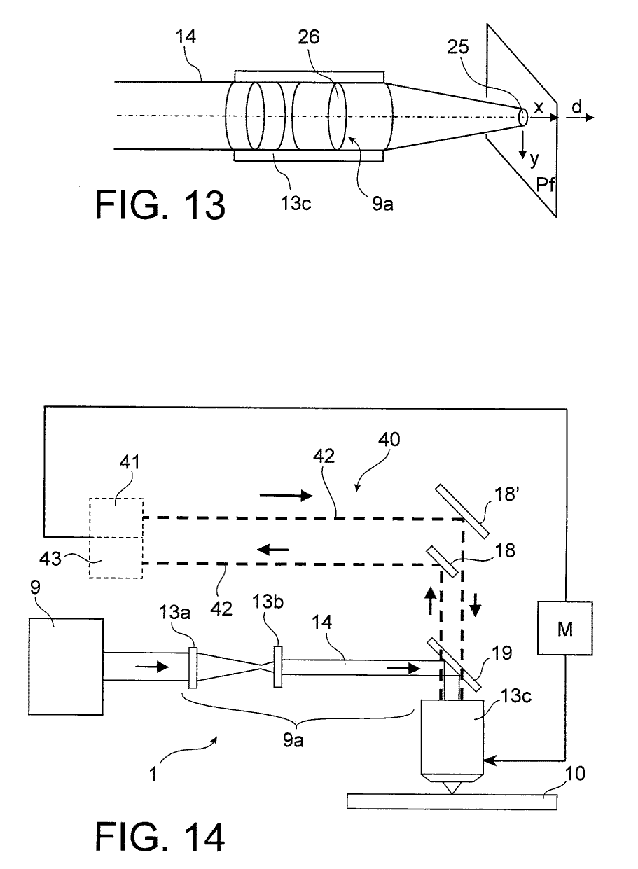

Another embodiment of the shaping means 9a making it possible to obtain an oblong spot 25 is illustrated in FIG. 13. They consist of using the non-symmetrical aberrations such as for example the coma or the astigmatism of at least one element of the focussing device 13c. Such aberrations are then intentionally introduced into the focussing device 13c that the shaping means 9a comprise, placed downstream of the laser (not shown), so as to degrade the focusing of the laser beam 14 in one direction. By way of example, an aberrant lens 26, a component of which is made cylindrical, has been shown within the focussing device 13c.

Other means could be used for obtaining the oblong stop, such a transformation not posing any problem for a person skilled in the art.

FIG. 14 depicts partially a device for recording graphical data on a medium 10 according to the invention, in which the writing device 1 cooperates with means 40 of slaving the shaping means 9a and more particularly with their focussing device 13c according to its distance from the medium 10 so as to keep the medium 10 in the focussing plane of the shaping means 9a. The shaping means 9 are shown in a similar manner to the configuration in FIG. 11 with a cylindrical telescope.

The slaving means 40 use a light source 41 that generates a light beam 42 referred to as a probe beam towards the focussing device 13c. The probe beam 42 propagates in the focussing device 13c while remaining at its periphery, to allow the slaving. The probe beam 42, after having passed through the focussing device 13c, is reflected on the medium 10 and returned to a detector 43. During defocussing, the probe beam 42 undergoes an angular deviation detected by the detector 43. Movement means M of the focussing device 13c and/or the medium 10 are provided and are activated as long as the defocussing has not been suppressed.

A set of two return mirrors 18, 18′ have been shown, for firstly angularly diverting the probe beam 42 on its outward path from the light source 41 to the focussing device 13c and secondly to divert the probe beam 42 on its return path from the focussing device 13c towards the detector 43. A semi-transparent sheet 19 has also been shown for firstly diverting the laser beam on its path between the laser 9 and the focussing device 13c and secondly allowing the probe beam 42 to pass on its outward or return path. If the medium 10 is in the focussing plane of the focussing device, the reflected probe beam 42 is not diverted and the movement means M are not activated. In this configuration, the cylindrical telescope with the lenses 13a, 13b does not interfere with the functioning of the slaving device 40 and the probe beam 42 does not pass through it since it is offset angularly with respect to the principal axis of the focussing device 13c. This advantage is absent if a writing device similar to one in FIG. 13 is used.

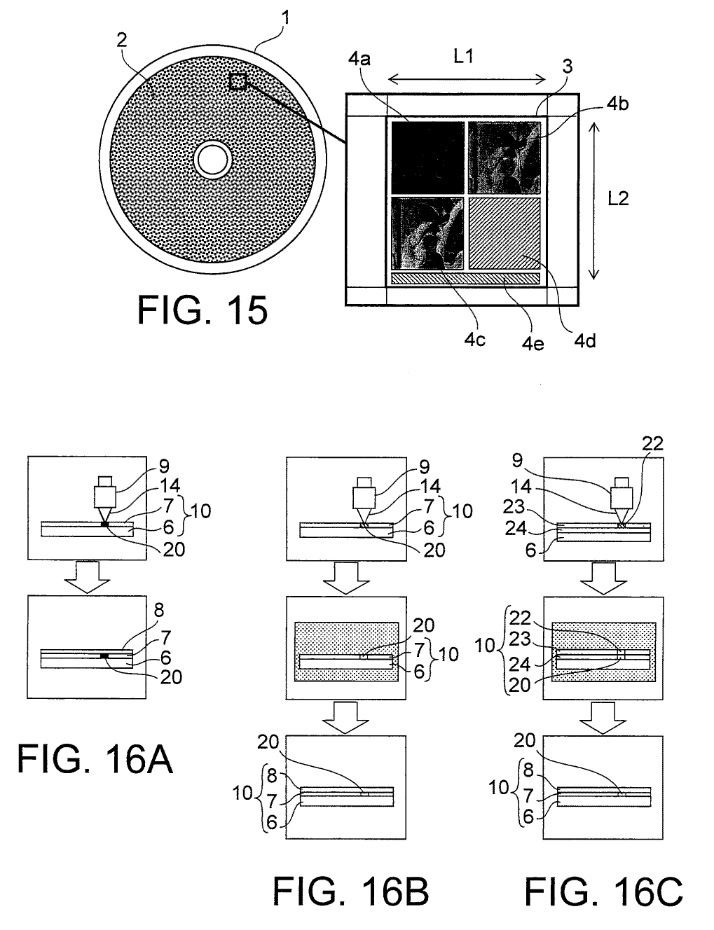

FIG. 15 shows the particular case where the medium 10 is an optical disc. The medium 10 comprises a zone 2 on which graphical data are stored by the recording method of the invention. The storage zone 2 is formed by a plurality of storage units 3 that will each contain data relating to a graphical data item. For example, in the case of a graphical data item in colour of the photograph type, the storage unit 3 will be able to contain at least three storage sub-units, 4a, 4b and 4c, which correspond to the different colours: for example the sub-unit 4a is allocated to blue, the sub-unit 4b to red, the sub-unit 4c to green. It will be able to contain other sub-units 4e and 4d which would for example contain information relating to the graphical data, such as for example the date of photographing, or more generally of creation, its focal length, its aperture or its size, and even other archiving characteristics. A sub-unit 4e can be used for locating the unit in the medium 1. The latter will be able to be coded for example in the form of typographical writing of the number type, for example, or of the digital type, for example a bar code. According to the graphical data type to be recorded the storage unit will be different. For example, if the graphical data to be recorded is single-colour with a single grey level, a single sub-unit may suffice; however, a second may be present for location on the medium.

Thus a graphical data item recorded on a storage unit containing for example five sub-units as defined above will have a total surface area Sᵤₙᵢₜ defined by:

Sᵤₙᵢₜ=D_{image}×p²×N_{sub-unit}

where:

D_{image} designates the definition of a graphical data item, for example in the case of a three-megapixel photograph, the definition D_{image} is equal to 2048×1536 pixels.

p corresponds to the side of a mesh in which a pattern is inscribed.

N_{sub-unit} is the number of sub-units for a storage zone.

In the case of a storage medium of the optical disc type the total surface area of storage is defined by:

Sₜₒₜₐₗ=π×(Rₘₐₓ²−Rₘᵢₙ²)

where:

Rₘₐₓ designates the maximum radius of the storage zone 2 of the disc,

Rₘᵢₙ designates the minimum radius of the storage zone 2 of the disc.

For example, if the meshes have a side P equal to 1 μm, and the number N_{sub-unit} of sub-units is 4, a storage zone has a size of 4.10×3.07 mm². Generally an optical disc has a surface area of 8600 mm². It is therefore possible to store approximately 680 photographs thereon. It is possible to increase the storage capacity by reducing the size of the pixels, but this degrades the dynamic range of the grey levels of the graphical data recorded and therefore their quality. The aim of the invention is to propose a recording device that affords a reliable saving and not necessarily a massive saving of graphical data. In a general-public application, the saving of a few hundreds of photographs per disc seems satisfactory.

It is possible to distinguish at least three types of processing to be applied to the medium 10 in order to inscribe patterns 20 thereon with the recording device of the invention.

FIG. 16a shows, in transverse section, a medium 10 used with the recording device of the invention in a first configuration. It comprises a base 6 formed for example from a disc made from plastics material of the type used in compact discs. The base 6 is surmounted by a material 7 sensitive to the illumination of the laser 9. To inscribe a pattern 20, the sensitive material 7 is subjected to the beam 14 of the laser modulated for power, the medium 10 and the laser 9 being given a sweep movement one with respect to the other. Under the effect of the laser beam 14, the sensitive material 7 is modified locally, and this modification concerns the optical contrast between the sensitive material 7 not irradiated by the laser beam 14 and the sensitive material 7 irradiated by the laser beam 14. Possibly surface protection 8 is provided, for example of the varnish type or of the plastic film type bonded to the sensitive material after inscription.

In FIG. 16B, the substrate 6 is covered with a layer 7 of material with low sensitivity to the illumination of the laser beam 14 but physico-chemical attack, as is the case, for example, with a layer of PtOx illuminated by a laser emitting at 405 nm. After illumination of a zone 22 by the laser beam 14, the insolated zone 22 is chemically attacked and dissolved by a chemical agent. This chemical agent may be an acid, such as aqua regia, in the example of PtOx as the sensitive material. A pattern corresponds to an absence of sensitive material 7. Finally, as before, it is possible to deposit a surface protective layer 8.

The last example illustrated in FIG. 16C concerns a conventional lithography method. The medium 6 is covered with a layer of opaque material 24, for example a metal such as chromium. A layer of resin 23 is deposited on the opaque layer 24. After illumination of a zone 22 of resin by the laser beam 14, the resin 23 is developed chemically and the layer of opaque material 24 is bared locally. The opaque material 24 bared is etched. A pattern 20 corresponds to a zone of opaque material or on the contrary to a zone without opaque material, this depending on the type of resin employed. Finally, as before, it is possible to deposit a surface protective layer 8.

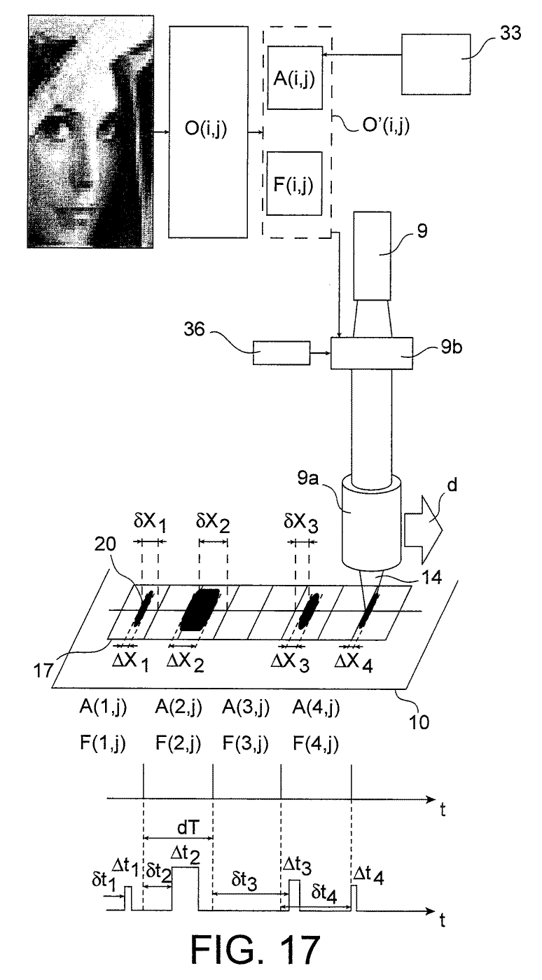

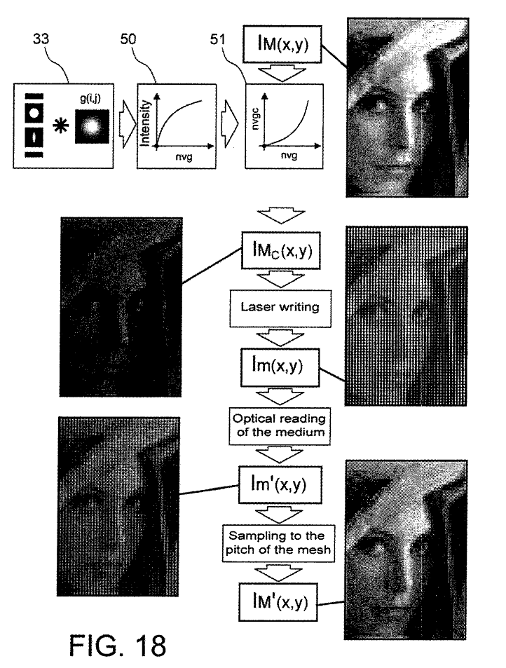

FIG. 17 illustrates a variant method of recording graphical data, in which the inscription of a pattern always makes it possible to record the grey level of a pixel but also makes it possible to record additional information. The additional information may be the phase, for example of the fast Fourier transform of an image to be recorded. This information is given by a decentring of the pattern in the mesh. This means that, in this variant, the pattern is no longer centred in the mesh.

The graphical data item 34 that has just been recorded is in digital form, and in grey level, coded for example in 256 grey levels. It can be put in the form of a matrix of values o(i, j), each element of which corresponds to a grey level. Next the fast Fourier transform (FFT) is calculated, or any other transform of this matrix of values. Then a matrix o′(i, j) of complex values is obtained. This matrix of complex values o′(i, j) can be broken down into a matrix of amplitudes A(i, j) and a matrix of phases F(i, j).

Each value of the complex matrix o′(i, j) is correlated with a pattern size and a position in the mesh by means of the conversion table 33, which gives for each amplitude A a pattern size and for each phase F a position of the pattern in the mesh.

Next a pattern 10 for each element of the matrix of complex values o′(i, j) is inscribed on the medium 10, in a mesh 17, the size of the pattern 20 being proportional to the amplitude of the element extracted from the matrix of amplitudes A(i,j). As described previously, to inscribe this pattern, the power of the laser 9 and/or the period for which the laser 9 is switched on is acted on by virtue of the adjustment means 9b. The phase of the element extracted from the matrix of phases F(i,j) is represented by the position of the corresponding pattern 20, in the mesh 17, and for this purpose the time of switching on of the laser 9, also given by the adjustment means 9b, is acted on. The meshes 17 are shown in solid lines in FIG. 17. The phase of the elements of the matrix of phases F(i,j) is generally between −π and +π modulo 2π.

Such a principle of recording the amplitude and phase has been presented for holography in the publication “Complex Spatial Filtering with Binary Masks” B R Brown and A Lohmann, Applied Optics, volume 5, number 6, pages 967-969.

The recording device of the invention comprises means 36 of synchronising the switching on of the laser that emit an electrical pulse as soon as the laser 9 passes over the centre of a mesh 17, as can be seen on the top time diagram in FIG. 17. These synchronisation means 36 cooperate with the adjustment means 9b. The time At for which the laser is switched on for inscribing a pattern 20 depends on the amplitude of the grey level that it is wished to code. In the case of a null phase, the pattern 20 is centred, that is to say it is switched on with a time advance Δt/2 with respect to the centre of the mesh 17. In the context of any phase lying between −π and +π, the pattern 20 is decentred by a distance δx that depends on the phase, with respect to the centre of the mesh 17. Thus, in FIG. 17, it is possible to observe three recorded patterns 20, the fourth being in the course of writing, each of these three patterns having a dimension Δx₁, Δx₂ and Δx₃ in the direction of the sweeping d and a different decentring δx₁, δx₂, δx₃. The patterns decentred by δx₁ and δx₂ have a phase lying between 0 and −π modulo 2π. The pattern decentred by δx₃ has a phase lying between 0 and +π modulo 2π. The pattern in the course of inscription will have a null phase modulo 2π.

The inscribed patterns correspond to elements of one and the same column j of the complex matrix O′(i, j) having as its amplitude A(1, j), A(2, j), A(3, j), A(4, j) and as its phase F(1, j), F(2, j), F(3, j), F(4, j).

If the time taken by the laser to sweep a mesh 17 is called dT, the time for which the laser 9 is switched on for saving a pattern 20 of given amplitude A is called At and the interval of time lying between the moment when the laser 9 passes over the centre of a mesh 17 just preceding the one in which a pattern 20 is about to be inscribed and the moment when the laser 9 is switched on to inscribe this pattern 20 is called δt, δt can be defined in the following manner:

If the pattern to be inscribed has a null phase F modulo 2π, then δt=dT−Δt/2

If the pattern to be inscribed has a phase F of −π modulo 2π then δt=(dT−Δt)/2

If the pattern to be inscribed has a phase F or +π modulo 2π then δt=(3 dT−Δt)/2.

In the figure the quantities Δt and δt are provided with indices 1 to 4 since they each relate to one of the patterns.

It is important to be able to have a maximum of mesh sizes and decentring in the meshes so that, when the recorded data are read, the result is as close as possible to the original. With the recording method according to the invention it is possible to benefit from a large number of grey levels and a great temporal resolution on the time when the laser is switched on.

FIG. 18 is a functional diagram showing firstly a method of recording graphical data according to the invention and secondly a method of reading graphical data recorded by the recording method. It is sought for the graphical data recovered to be as close as possible to the original graphical data that were recorded.

The device for reading recorded data will first of all be described with reference to FIG. 2.

The device for reading graphical data 1′ recorded by the recording device must be adapted to the recording device. It comprises a laser 9′ that delivers a laser beam 14′ towards the medium 10 on which the graphical data had been recorded in the form of patterns, this laser beam 14′ is reflected by the medium 10 and returned towards an optical connection device 9a′ and then a processing device 31 that delivers the graphical data recovered in a digital form. The optical collection device 9a′ is characterised by a percussional response g(x,y). A graphical data item to be recorded is designated IM(x,y) and the analogous graphical data item as recorded on the medium 10 is designated Im(x,y). The reading of the recorded graphical data item Im(x,y) by the reading device that is the object of the invention gives a new graphical data item referred to as the recovered graphical data item IM′(x,y), which is the result of the convolution Im(x,y)*g(x,y). The objective is that the difference between IM′(x,y) and IM(x,y) is a small as possible. It is necessary to take into account the effect of the convolution of g(x, y) during saving.

The conversion table 33 takes into account the percussional response g(x,y) of the optical collection device 9a′ and corresponds to the result of the numerical convolution of all the sizes of patterns with the percussional response g(x,y). The percussional response g(x,y) is generally of the Gaussian type with a waist. This Gaussian function approximates to the response of the optical collection device 9a′. The optical connection device and/or the shaping means can comprise an apodisation function, that is to say reduction of the secondary lobes of the focussing spot. It is possible to use for example an optical collection device and/or the shaping means such that the waist is 500 nm.

A convolution dynamic range is obtained that gives for each grey level the intensity of the laser beam 14, that is to say the power of the laser (block 50). This dynamic range obtained is inverted in order to obtain the correction function (block 51).

In an additional step, the graphical data Im(x,y) is-corrected by means of the correction function of the block 51. Then a corrected graphical data item Im_{c}(x,y) is obtained. It is this corrected graphical data item Im_{c}(x,y) that will be written on the medium 20 by means of the writing device 1. The graphical data item recorded is called Im(x,y). Next it is possible to read the medium 10 with the collection optics 9a′. A graphical data item Im′(x,y) is obtained that it suffices to sample at the pitch of the mesh 17 in order to obtain the graphical data item IM′(x,y) that is as close as possible to the original graphical data item to be recorded IM(x,y).

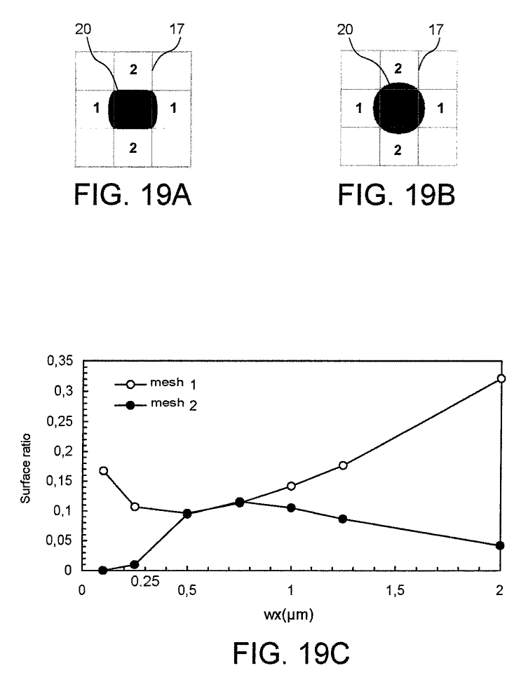

The dimension wx′ of the spot in the sweep direction will have an influence on the form of the pattern inscribed. The smaller the dimension wx′, the more rectangular (or square) will be the pattern inscribed, as illustrated in FIG. 17A with a value of wx′ of 0.25 micrometres. The smaller the dimension wx′, the more the inscribed pattern 20 will be circular as in FIG. 19B with a value of wx′ of 1 micrometre.

A rectangular or square shape has the advantage that the pattern, if it occupies the entire surface of the mesh, does not overflow excessively onto the adjoining meshes and does not complicate the determination of the grey level when the recorded graphical data are read.

A circular pattern has the advantage of giving a softer recovered image.

FIG. 19C shows the surface ratio occupied by a pattern that overflows onto an adjoining mesh, called N^{o} 1 or N^{o} 2 according to the dimension wx′ of the spot that serves to inscribe the pattern. It is assumed that the meshes have a side of approximately 1 micrometre and that the inscription medium is of the photosensitive type. For a dimension wx′ of less than 0.25 micrometres, the percentage overflow into the mesh 2 situated in the same column as the inscribed mesh is less than 1%. For a dimension wx′ equal to 0.5 micrometres, the percentage overflow into the mesh 2 is 10%. In both cases the percentage overflow into the meshes 1 situated on the same row as the inscribed mesh is greater than or equal to 10%.

In conclusion, if the objective of the saving is the preservation of the quality of the data, the reproduction of the dynamic range of the grey levels is optimised. For this purpose there is an advantage in working with a spot the dimension wx′ of which is small and is typically equal to around 20% of the side of a mesh, as shown in FIG. 19A.

On the other hand, if the objective is to carry out an aesthetic saving from an image reduced in size for the eye, a dimension wx′ for the spot of around 50% to 75% of the side of the mesh will be chosen as shown in FIG. 19B.

The present invention proposes a solution for saving graphical data adapted both to the saving of a large quantity of graphical data and to a faithful saving of graphical data. These two objectives are contradictory. This is because the value of the side of the mesh will depend on the objective sought.

The minimum pitch of the laser spot is equal to the ratio of the linear speed to the characteristic frequency of the laser. With a characteristic frequency of 400 MHz and a linear speed of 1 m/s, the minimum pitch of the laser spot is equal to 2.5 nanometres. In order to be able to benefit from 256 grey levels, a mesh must have a side of a minimum of 640 nanometres. The smaller the mesh, the more graphical date will be able to be recorded on the medium.

For a better aesthetic rendition, the size of the mesh will be adapted to the resolution of the device reading the graphical data recorded. Typically, the side of a mesh will be able to exceed one micrometre.

It should also be noted that, with high mesh sizes, it is possible to obtain shorter writing periods, since the pitch of the spiral travelled by the laser, in the case of saving on a disc, is greater. In a general-public application of the recording device, it will therefore be advantageous to favour high mesh sizes.

Although several embodiments of the present invention have been depicted and described in detail, it will be understood that various changes and modifications can be made without departing from the scope of the invention.

1. Device for recording graphical data (34) on a medium (10), each graphical data item having pixels that can take several grey levels, comprising a laser (9) producing a laser beam (14) to which the medium (10) is sensitive, this laser beam (14) projecting a spot (25) onto the medium (10), the laser (9) being driven in a relative sweeping movement with respect to the medium (10) during recording, characterised in that it comprises means of converting the grey level of each pixel into a pattern size (20) to be recorded on the medium (10), means (9a) for shaping the laser beam (14) so that the spot (25) projected onto the medium (10) is oblong and has a dimension in the sweep direction smaller than a dimension in a direction substantially perpendicular to the sweep direction, and means of adjusting the size of the pattern (9b) acting on the switching on and off of the laser (9) and/or the power of the laser beam (14).

2. Recording device according to claim 1, in which the means (9a) for shaping the laser beam (14) comprise a focussing device (13c) placed downstream of the laser (9).

3. Recording device according to claim 2, in which the means (9a) for shaping the laser beam (14) comprise a cylindrical telescope with at least two cylindrical lenses (13a, 13b) with different focal lengths, placed downstream of the laser (9) and upstream of the focussing device (13c).

4. Recording device according to claim 3, in which at least one of the cylindrical lenses (13a, 13b) is exchangeable.

5. Recording device according to claim 2, in which the means (9a) for shaping the laser beam (14) comprise an obturator (27) placed downstream of the laser (9) and focussing device (13c).

6. Recording device according to claim 1, in which the means (9a) for shaping the laser beam (14) comprise at least one aberrant element (26) included in the focussing device (13c).

7. Recording device according to claim 1, also comprising means (40) of slaving the position of the shaping means (9a) with respect to the medium (10).

8. Recording device according to claim 1, in which the means of adjusting the size of the pattern (9b) comprise means of modulating the laser beam (9).

9. Recording device according to claim 1, in which means of converting the grey level of each pixel into a pattern size (20) to be recorded comprise a conversion table (33).

10. Recording device according to claim 1, in which each pattern (20) is inscribed in a mesh (17) on the medium (10), the means of adjusting the size of the pattern (20) adjusting both the period for which the laser (9) is switched on and the start of the switching on so that each pattern (20) is centred or decentred in the mesh (17).

11. Recording device according to claim 10, in which, when the pattern (20) is decentred in the mesh (17), the size of the pattern (20) represents the amplitude of a transform of the grey level and its decentring the phase of a transform of the grey level.

12. Recording device according to claim 1, in which the means of adjusting the size of the pattern (9b) and/or the conversion means (32) take into account the nature of the medium (10).

13. Device for recording and reading graphical data (34), comprising a recording device according to claim 1 and a device for reading the graphical data (34) recorded by the recording device that comprises a laser (9′) intended to irradiate the medium (10) with a laser beam (14′) and an optical device (9a′) for collecting the laser beam (14′) that has interacted with the medium (10), in which the means for correlating the grey level of each pixel with a pattern size (20) to be recorded on the medium 10) takes into account a percussional response of the optical collecting device (9a′).

14. Laser recording method of graphical data (34) on a medium (10) sensitive to a laser beam (14) produced by the laser (9), each graphical data item having pixels that can take several grey levels, in which:
for each pixel of the graphical data item a pattern size (20) to be recorded on the medium (10) is determined, this size depending on the grey level of the pixel,
the laser (9) and the medium (10) are driven in a relative sweeping movement,
the laser beam (14) is shaped so that it projects an oblong spot (25) on the medium (10), this spot (25) having a dimension in the sweep direction smaller than a dimension in a direction substantially perpendicular to the sweep direction,
the switching on and off of the laser (9) and/or the power of the laser beam (14) are acted on so that the pattern (20) being recorded has the required size.

15. Recording method according to claim 14, in which each pattern (20) is recorded in mesh (17) on the medium (10), the meshes (17) forming a succession, the switching on of the laser (9) is adjusted for the recording of a pattern (20) in a given mesh (17) as from an instant in which the laser passes over the centre of the mesh (17) preceding the given mesh (17).

16. Recording method according to claim 14, in which the power of the laser (9) is regulated for adjusting the dimension of the spot (25) in the direction substantially perpendicular to the sweep direction.
